(19) United States
(12) Patent Application Publication
(10) Pub. No.: US 2024/0362685 A1
(43) Pub. Date: Oct. 31, 2024

(54) USED CAR TRANSACTION BROKERING SYSTEM AND METHOD

(71) Applicants: HYUNDAI MOTOR COMPANY, Seoul (KR); KIA CORPORATION, Seoul (KR)

(72) Inventor: Yeong Hyeon Kang, Seoul (KR)

(73) Assignees: HYUNDAI MOTOR COMPANY, Seoul (KR); KIA CORPORATION, Seoul (KR)

(21) Appl. No.: 18/367,861

(22) Filed: Sep. 13, 2023

(30) Foreign Application Priority Data
Apr. 27, 2023 (KR) 10-2023-0055559

(51) Int. Cl. G06Q 30/02

(52) U.S. Cl. CPC G06Q 30/0278

(57) ABSTRACT

A used car transaction brokering system and a method thereof, enable presenting the best transaction to both a seller and a buyer. Upon receiving disapproval of a purchase price and a request to receive estimate prices to be compared with each other from a seller terminal, the transaction brokering system and method transmit characteristics information and an appearance image of a used car to a plurality of buying company terminals located within a preset distance from a position of the used car. The transaction brokering system and method transmit the estimated prices respectively received from the plurality of buying company terminals to the seller terminal.

### CROSS-REFERENCE TO RELATED APPLICATION

This application claims the benefit of priority to Korean Patent Application No. 10-2023-0055559, filed in the Korean Intellectual Property Office on Apr. 27, 2023, the entire contents of which are incorporated herein by reference.

### TECHNICAL FIELD

The present disclosure relates to a technique for brokering a used car transaction between a car owner and a buying company (e.g., an export company or a scrap car company).

### BACKGROUND

In general, used car transaction schemes includes an offline scheme in which a car owner visits a plurality of used car transaction dealers, shows a used car to each of the dealers, and sells the used car to the dealer who offers the highest buying price. The used car transaction schemes also include an online scheme using a transaction site in which a car owner registers the used car and uploads images of the exterior and interior of the used car. A number of dealers check the condition of the used car and then place a bid offering buying prices on the used car transaction site. The car owner sells the used car to the dealer that has offered the highest buying price.

In this regard, the off-line scheme is inconvenient because, in order to negotiate the sales price of the used car, the car owner must individually meet face to face with several used car dealers, which in turn visually inspect the used car.

In addition, the online process has inherent problems due to asymmetry of information between the seller and the buyer. In other words, the seller knows the condition of the used car. However, it is difficult for the seller to determine the market price based on the condition. The buyer does not know the exact condition of the used car. Thus, there is a limit for the buyer to estimate a proper price of the used car.

A scheme of removing such asymmetry of information to present the best transaction to both the seller and the buyer would be beneficial.

Subject matter described in this background art section is provided to enhance understanding of the background of the present disclosure. The background art section may include subject matter other than the prior art already known to those of ordinary skill in the art to which the present disclosure belongs.

### SUMMARY

The present disclosure has been made to solve the above-mentioned problems occurring in the prior art while advantages achieved by the prior art are maintained intact.

Aspects of the present disclosure provides a used car transaction brokering system and a method thereof capable of presenting the best transaction to both a seller and a buyer. The used car transaction brokering system and method receive data indicative of unique information, an appearance image, and position information of the used car from a seller terminal. The system and method further acquire characteristics information of the used car from a user car management server using the unique information of the used car and acquire a market price of the used car from a market price management server based on the characteristics information of the used car. The system and method further acquire a maintenance estimate cost from a maintenance company server based on the appearance image of the used car, determine a proper price of the used car by subtracting the maintenance estimate cost from the market price of the used car, and transmit the proper price of the used car to the seller terminal. The system and method further retrieve the purchase price of the used car from the table and transmit the purchase price of the used car to the seller terminal for approval by the seller or the seller terminal, based on the purchase price. The seller or seller terminal may approve or reject the purchase price, and if rejected, may request other estimate prices. Upon receiving a request to receive estimate prices to be compared with each other from the seller terminal, the system and method transmit the characteristics information and the appearance image of the used car to a plurality of buying company terminals located within a preset distance from a position of the used car. The system and method transmit the estimate prices respectively received from the plurality of buying company terminals to the seller terminal.

Another aspect of the present disclosure provides a used car transaction brokering system and method capable of presenting the best transaction to both the seller and the buyer. In an embodiment, when brokering a used car transaction between a car owner, i.e., seller, and a used car export company, the used car transaction brokering system and method receive data indicative of the unique information, the appearance image, and the position information of the used car from the car owner, i.e., seller terminal. The system and method further acquire the characteristics information of the used car from a used car management server based on the unique information of the used car, acquire the market price of the used car from a market price management server based on the characteristics information of the used car, and acquire the maintenance estimate cost from a maintenance company server using the appearance image of the used car. The system and method further determine a proper export price of the used car by subtracting the maintenance estimate cost from the market price of the used car and transmit the proper export price of the used car to the car owner, i.e., seller, terminal. The system and method further retrieve the export price of the used car from the table in which the export price based on the characteristics information of the car is recorded and transmit the export price of the used car to the car owner terminal for approval by the car owner or the car owner terminal, based on the export price. The car owner or car owner terminal may approve or reject the export price, and if rejected, may request other estimate prices. Upon receiving a request to receive estimate prices to be compared with each other from the car owner terminal, the system and method further transmit the characteristics information and the appearance image of the used car to a plurality of export company terminals located within a preset distance from the position of the used car. The system and method further transmit the estimate prices respectively received from the plurality of export company terminals to the car owner terminal.

Still another aspect of the present disclosure provides a used car transaction brokering system and method capable of presenting the best transaction to both the seller and the buyer. In an embodiment, when brokering a transaction between a car owner, i.e., seller, and a scrap car company, the used car transaction brokering system and method receive data indicative of the unique information, the appearance image, and the position information of the used car from the car owner, i.e., seller terminal. The system and method further acquire the characteristics information of the used car from a user car management server based on the unique information of the used car. The system and method further acquire the market price of the used car from a market price management server based on the characteristics information of the used car and determine a damage level of the used car using the appearance image of the used car. The system and method further determine a proper scrap car price of the used car by subtracting a repair cost corresponding to the damage level from the market price of the used car and transmit the proper scrap car price of the used car to the car owner terminal. The system and method further retrieve the scrap car price of the used car in the table in which the scrap car price based on the characteristics information of the car is recorded and transmit the scrap car price of the used car to the car owner terminal for approval by the car owner or the car owner terminal, based on the scrap car price. Upon receiving a request to receive estimate prices to be compared with each other from the car owner terminal, the system and method further transmit the characteristics information and the appearance image of the used car to a plurality of scrap car company terminals located within a preset distance from the position of the used car. The system and method further transmit estimate prices respectively received from the plurality of scrap car company terminals to the car owner terminal.

The technical problems to be solved by the present disclosure are not limited to the aforementioned problems. Any other technical problems not mentioned herein should be more clearly understood from the following description by those of ordinary skill in the art to which the present disclosure pertains.

According to an aspect of the present disclosure, a used car transaction brokering device includes a storage storing therein a table in which a purchase price based on characteristics information of a car is recorded. The device further includes a controller that receives data indicative of unique information, an appearance image, and position information of the used car from a seller terminal. The device further acquires characteristics information of the used car based on the unique information of the used car and acquires a market price of the used car based on the characteristics information of the used car. The device further acquires a maintenance estimate cost using the appearance image of the used car and determines a proper price of the used car by subtracting the maintenance estimate cost from the market price of the used car. The device further transmits the proper price of the used car to the seller terminal, retrieves the purchase price of the used car from the table and transmits the purchase price of the used car to the seller terminal. Upon receiving a request to receive estimate prices to be compared with each other from the seller terminal, the device further transmits the characteristics information and the appearance image of the used car to a plurality of buying company terminals located within a preset distance from a position of the used car. The device further transmits the estimate prices respectively received from the plurality of buying company terminals to the seller terminal.

In one implementation, the storage may store therein a table in which an export price based on characteristics information of a car is recorded.

In one implementation, when brokering a used car transaction between a car owner or the seller and a used car export company, the controller may receive data indicative of the unique information, the appearance image, and the position information of the used car from the car owner terminal. The device may further acquire the characteristics information of the used car based on the unique information of the used car and acquire the market price of the used car using the characteristics information of the used car. The device may further acquire the maintenance estimate cost using the appearance image of the used car and determine a proper export price of the used car by subtracting the maintenance estimate cost from the market price of the used car. The device may further transmit the proper export price of the used car to the car owner terminal and retrieve the export price of the used car from the table in which the export price based on the characteristics information of the car is recorded. The device may further transmit the export price of the used car to the car owner terminal. Upon receiving a request to receive estimate prices to be compared with each other from the car owner terminal, the device may further transmit the characteristics information and the appearance image of the used car to a plurality of export company terminals located within a preset distance from the position of the used car. The device may further transmit estimate prices respectively received from the plurality of export company terminals to the car owner terminal.

In one implementation, the controller may determine a price reduction rate of the used car based on a market price history of the used car and apply the price reduction rate of the used car to the proper export price of the used car to determine a future market price of the used car.

In one implementation, the storage may store therein a table in which a scrap car price based on characteristics information of a car is recorded.

In one implementation, when brokering a transaction between a car owner or the seller and a scrap car company, the controller may receive data indicative of the unique information, the appearance image, and the position information of the used car from the car owner terminal. The controller may further acquire the characteristics information of the used car based on the unique information of the used car and acquire the market price of the used car using the characteristics information of the used car. The controller may further determine a damage level of the used car using the appearance image of the used car and determine a proper scrap car price of the used car by subtracting a repair cost corresponding to the damage level from the market price of the used car. The controller may further transmit the proper scrap car price of the used car to the car owner terminal and retrieve the scrap car price of the used car in the table in which the scrap car price based on the characteristics information of the car is recorded. The controller may further transmit the scrap car price of the used car to the car owner terminal. Upon receiving a request to receive estimate prices to be compared with each other from the car owner terminal, the controller may transmit the characteristics information and the appearance image of the used car to a plurality of scrap car company terminals located within a preset distance from the position of the used car and transmit estimate prices respectively received from the plurality of scrap car company terminals to the car owner terminal.

In one implementation, the controller may acquire the maintenance estimate cost using a deep learning model that has been trained.

In one implementation, the deep learning model may output the maintenance estimate cost corresponding to the appearance image of the used car.

In one implementation, the unique information may include a license plate number and a vehicle identification number of the used car.

In one implementation, the characteristics information may include at least one of a manufacturer, a vehicle type, a model name, a class (option), a color, a manufacturing year, a displacement, a type of fuel, a transmission type, a cumulative mileage, an acquisition price, a maintenance history, an insurance history, a lease and rental history, a car owner history, or any combination thereof.

According to another aspect of the present disclosure, a used car transaction brokering method includes storing, into a storage, a table in which a purchase price based on characteristics information of a car is recorded. The method includes receiving, by a controller, data indicative of unique information, an appearance image, and position information of the used car from a seller terminal. The method further includes acquiring, by the controller, characteristics information of the used car using the unique information of the used car. The method further includes acquiring, by the controller, a market price of the used car using the characteristics information of the used car and acquiring, by the controller, a maintenance estimate cost using the appearance image of the used car. The method further includes determining, by the controller, a proper price of the used car by subtracting the maintenance estimate cost from the market price of the used car, transmitting, by the controller, the proper price of the used car to the seller terminal. The method further includes retrieving, by the controller, the purchase price of the used car from the table and transmitting, by the controller, the purchase price of the used car to the seller terminal. Upon receiving a request to receive estimate prices to be compared with each other from the seller terminal, the method further includes transmitting, by the controller, the characteristics information and the appearance image of the used car to a plurality of buying company terminals located within a preset distance from a position of the used car. The method further includes transmitting, by the controller, estimate prices respectively received from the plurality of buying company terminals to the seller terminal.

In one implementation, the method may further include storing, into the storage, a table in which an export price based on characteristics information of a car is recorded.

In one implementation, retrieving, by the controller, the purchase price of the used car may include, when brokering a used car transaction between a car owner or the seller and a used car export company, retrieving, by the controller, the export price of the used car from the table in which the export price based on the characteristics information of the car is recorded.

In one implementation, acquiring, by the controller, the market price of the used car may include determining, by the controller, a price reduction rate of the used car based on a market price history of the used car, and applying, by the controller, the price reduction rate of the used car to the proper export price of the used car to determine a future market price of the used car.

In one implementation, the method may include, storing, into the storage, a table in which a scrap car price based on characteristics information of a car is recorded.

In one implementation, determining, by the controller, the proper price of the used car may include, in brokering a transaction between a car owner or the seller and a scrap car company, determining, by the controller, a damage level of the used car using the appearance image of the used car, and determining, by the controller, a proper scrap car price of the used car by subtracting a repair cost corresponding to the damage level from the market price of the used car.

In one implementation, the acquiring, by the controller, of the maintenance estimate cost may include acquiring, by the controller, the maintenance estimate cost using a deep learning model that has been trained.

In one implementation, the deep learning model may output the maintenance estimate cost corresponding to the appearance image of the used car.

In one implementation, the unique information may include a license plate number and a vehicle identification number of the used car.

In one implementation, the characteristics information may include at least one of a manufacturer, a vehicle type, a model name, a class (option), a color, a manufacturing year, a displacement, a type of fuel, a transmission type, a cumulative mileage, an acquisition price, a maintenance history, an insurance history, a lease and rental history, a car owner history, or any combination thereof.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a configuration diagram of a used car transaction brokering system according to an embodiment of the present disclosure;

FIG. 2 is a configuration diagram of a used car transaction brokering device according to an embodiment of the present disclosure;

FIG. 3 is a flowchart for illustrating a used car transaction brokering method according to an embodiment of the present disclosure; and

FIG. 4 is a block diagram showing a computing system for executing a used car transaction brokering method according to an embodiment of the present disclosure.

### DETAILED DESCRIPTION

Hereinafter, some embodiments of the present disclosure are described in detail with reference to the drawings. In adding the reference numerals to the components of each drawing, it should be noted that the identical or equivalent component is designated by the identical numeral even when they are displayed on other drawings. Further, in describing the embodiments of the present disclosure, a detailed description of the related known configuration or function has been omitted where it has been determined that it would have interfered with the understanding of the embodiments of the present disclosure.

In describing the components of the embodiments according to the present disclosure, terms such as first, second, A, B, (a), (b), and the like may be used. These terms are merely intended to distinguish the components from other components, and the terms do not limit the nature, order, or sequence of the components. Unless otherwise defined, all terms including technical and scientific terms used herein have the same meaning as commonly understood by one of ordinary skill in the art to which this disclosure belongs. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

Further, when an element in the written description and claims is described as being “for” performing or carrying out a stated function, step, set of instructions, or the like, the element may also be considered as being “configured to” do so.

Throughout the specification, when a part is to be “connected” to another part, this includes direct connections as well as indirect connections. Indirect connections include connections via a wireless communication network.

Also, it is to be understood that the terms “comprise”, “include”, and “have” and variations thereof are intended to indicate the existence of components or elements in the specification and are not intended to preclude or to exclude the possibility that one or more other components or elements may exist or may be added, unless specifically stated to the contrary.

Further, the term “characteristics information of the used car” may refer to information including data indicative of characteristics of the used car. Also, the terms seller and car owner may be used interchangeably herein. However, the seller may also be a person or entity that is discharged by a car owner to sell or dispose of a used car for the car owner, whereas the car owner may be a person or entity that owns or holds title to the used car to be sold or disposed of.

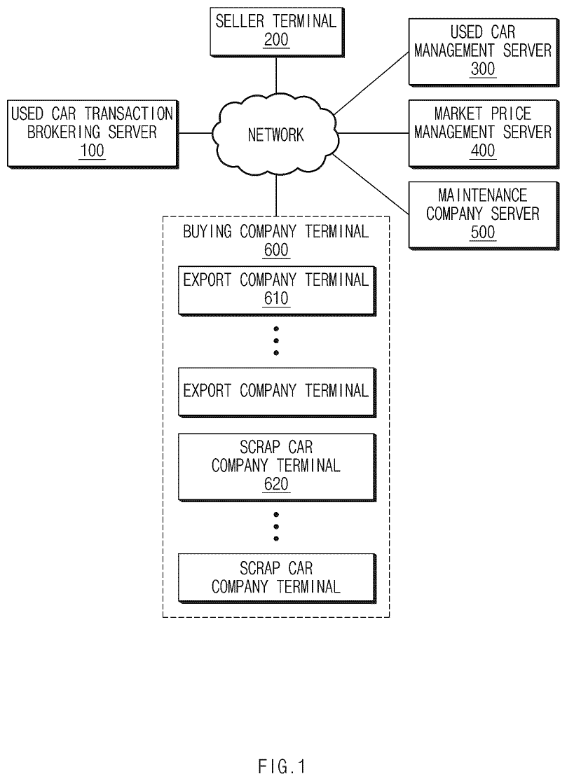

FIG. 1 is a configuration diagram of a used car transaction brokering system according to an embodiment of the present disclosure.

As shown in FIG. 1, a used car transaction brokering system according to an embodiment of the present disclosure includes a used car transaction brokering server (or a used car transaction brokering device) 100, a seller terminal (or a car owner terminal) 200, a used car management server 300, a market price management server 400, a maintenance company server 500, and a buying company terminal 600. In this regard, according to a scheme in which the used car transaction brokering system is implemented, the components may be combined with each other to be implemented into one component, and some components may be omitted.

Each of the above components are described below. The used car transaction brokering server 100 may receive unique information, an appearance image, and position information of the used car from the seller terminal 200. The server 100 may acquire characteristics information of the used car from the used car management server 300 based on the unique information of the used car. The server 100 may obtain a market price of the used car from the market price management server 400 based on the characteristics information of the used car. The server 100 may acquire a maintenance estimate cost from the maintenance company server 500 based on the appearance image of the used car. The server 100 may subtract the maintenance estimate cost from the market price of the used car to determine a proper price of the used car and transmit the proper price of the used car to the seller terminal 200. The server 100 may retrieve a purchase price of the used car from a table in which the purchase price based on the characteristics information of a car is recorded. The table may be stored in a non-transitory memory coupled with the used car transaction server 100. The used car transaction server 100 may transmit the purchase price of the used car to the seller terminal 200. The seller or car owner via the seller or car owner terminal 200 may accept or reject the purchase price. If rejected, the seller terminal 200 may send a request to receive estimate prices to the used car transaction server 100. Upon receiving the request to receive estimate prices to be compared with each other from the seller terminal 200, the used car transaction server 100 may transmit the characteristics information and the appearance image of the used car to a plurality of buying company terminals 600 located within a preset distance from a position of the used car. The server 100 may transmit the estimate prices respectively received from the plurality of buying company terminals 600 to the seller terminal 200. The seller terminal 200 may determine that the buying company offering the highest price is the buying company to which to sell the used car.

Furthermore, in an embodiment, when brokering a used car transaction between a car owner and a used car export company, the used car transaction brokering server 100 may receive unique information, an appearance image, and position information of the used car from the car owner terminal 200. The server 100 may further acquire the characteristics information of the used car from the used car management server 300 based on the unique information of the used car and acquire the market price of the used car from the market price management server 400 based on the characteristics information of the used car. The server 100 may further acquire the maintenance estimate cost from the maintenance company server 500 using the appearance image of the used car, determine a proper export price of the used car by subtracting the maintenance estimate cost from the market price of the used car, and transmit the proper export price of the used car to the car owner terminal 200. The server 100 may further retrieve the export price of the used car from the table in which the export price based on the characteristics information of the car is recorded and transmit the export price of the used car to the car owner terminal 200. The car owner may accept or reject the export price and, if rejected, may request other estimate prices. Upon receiving a request to receive estimate prices to be compared with each other from the car owner terminal 200, the server 100 may further transmit the characteristics information and the appearance image of the used car to a plurality of export company terminals 610 located within a preset distance from the position of the used car and transmit the estimate prices respectively received from the plurality of export company terminals 610 to the car owner terminal 200. Again, the car owner terminal 200 may compares the estimate prices to determine and select the best or highest estimate price.

In this embodiment, the used car transaction brokering server 100 may acquire a market price history of the used car from the market price management server 400, determine a price reduction rate of the used car based on the market price history of the used car, and apply the price reduction rate of the used car to the proper export price of the used car or the proper price of the used car to determine a future market price of the used car.

Furthermore, in another embodiment, when the used car transaction brokering server 100 brokers a transaction between a car owner and a scrap car company dealer, the used car transaction brokering server 100 may receive the unique information, the appearance image, and the position information of the used car from the car owner terminal 200. The server 100 may further acquire the characteristics information of the used car from the used car management server 300 based on the unique information of the used car and acquire the market price of the used car from the market price management server 400 based on the characteristics information of the used car. The server 100 may determine a damage level of the used car using the appearance image of the used car and determine a proper scrap car price of the used car by subtracting a repair cost corresponding to the damage level from the market price of the used car. The server 100 may transmit the proper scrap car price of the used car to the car owner terminal 200, retrieve the scrap car price of the used car from the table in which the scrap car price based on the characteristics information of the car is recorded/stored, and transmit the scrap car price of the used car to the car owner terminal 200. The car owner or seller via the car owner or seller terminal 200 may accept or reject the scrap car price and, if rejected, may request other estimate prices. Upon receiving a request to receive estimate prices to be compared with each other from the car owner terminal 200, the server 100 may transmit the characteristics information and the appearance image of the used car to a plurality of scrap car company terminals 620 located within a preset distance from the position of the used car. The used car transaction brokering server 100 may transmit the estimate prices respectively received from the plurality of scrap car company terminals 620 to the car owner terminal 200. The car owner or seller or the car owner or seller terminal 200 may compare the estimate prices to determine and select the best or highest estimate price.

In an embodiment, the unique information may include a license plate number and a vehicle identification number of the used car. The characteristics information may include at least one of a manufacturer, a vehicle type, a model name, a class (option), a color, a manufacturing year, a displacement, a type of fuel, a transmission type, a cumulative mileage, an acquisition price, a maintenance history, an insurance history, a lease and rental history, a car owner history, or any combination thereof.

The seller terminal 200 may act as the car owner terminal and may transmit the unique information, the appearance image, and the position information of the used car input from the car owner to the used car transaction brokering device 100.

The used car management server 300 may manage data indicative of a manufacturer, a vehicle type, a model name, a class (option), a color, a manufacturing year, a displacement, a type of fuel, a transmission type, a cumulative mileage, an acquisition price, a maintenance history, an insurance history, a lease and rental history, and a car owner history of each of the used cars.

The market price management server 400 may monitor the market price of each of various used cars based on the manufacturer, the vehicle type, the model name, the class, the color, the manufacturing year, the displacement, the type of fuel, and the cumulative mileage.

The maintenance company server 500 may receive the maintenance estimate cost corresponding to the appearance image of the used car determined by a car mechanic, and a damage level (e.g., a level 1 to a level 10) determined by the car mechanic. In this regard, the maintenance estimate cost may include a part price, a repair labor, a painting cost, and the like, for damage repair. Furthermore, the car mechanic may determine the damage level based on the number of scratches, scratch positions, deterioration in aesthetic sensibility, and abnormalities in the painted condition. Furthermore, the car mechanic may determine, based on the appearance image, whether the used car had an accident, a position of the damaged part, a type of the accident, and a level of accident damage, and calculate a price reduction rate based on the accident information and the level of the damage, and determine the damage level of the damaged part as a level from a level 1 to a level 10.

The buying company terminal 600 may include at least one export company terminal 610 and at least one scrap car company terminal 620. The export company terminal 610 may transmit the estimated price determined by a corresponding export company dealer to the used car transaction brokering server 100. The scrap car company terminal 620 may transmit the estimated price determined by the scrap car company dealer to the used car transaction brokering server 100. In this embodiment, each of the export company dealer and the scrap car company dealer may determine a buying estimate price based on the appearance image, the car plate number, the vehicle identification number, the manufacturer, the vehicle type, the model name, the class, the color, the manufacturing year, the displacement, the type of fuel, the type of transmission, the cumulative mileage, a buying price of the same vehicle type, and a selling price of the same vehicle type.

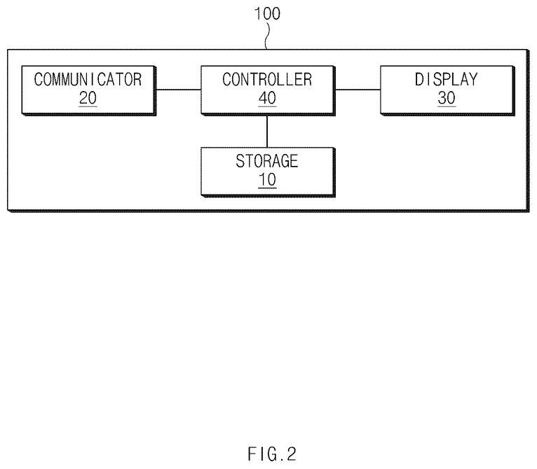

FIG. 2 is a configuration diagram of a used car transaction brokering device according to an embodiment of the present disclosure.

As shown in FIG. 2, the used car transaction brokering device 100 according to an embodiment of the present disclosure may include a storage 10, a communicator 20, a display 30, and a controller 40. The storage 10 may refer to a storage medium. In this embodiment, according to a scheme or process in which the used car transaction brokering device 100 is implemented, the components may be combined with each other to be integrated into one component. Further, some components may be omitted.

Each of the above components is described below. The storage 10 may store therein various logics, algorithms, and programs required in the disclosed method. The method may include receiving unique information, an appearance image, and position information of the used car from the seller terminal 200. The method may further include acquiring characteristics information of the used car from the used car management server 300 based on data indicative of the unique information of the used car and obtaining a market price of the used car from the market price management server 400 based on the characteristics information of the used car. The method may further include acquiring a maintenance estimate cost from the maintenance company server 500 based on the appearance image of the used car, subtracting the maintenance estimate cost from the market price of the used car to determine a proper price of the used car, and transmitting the proper price of the used car to the seller terminal. The method may further include retrieving a purchase price of the used car from a table in which the purchase price based on characteristics information of a car is recorded. The method may further include transmitting the purchase price of the used car to the seller terminal 200. The seller or car owner or the seller or car owner terminal 200 may accept or reject the purchase price and, if rejected, and may send a request to receive estimate prices. Upon receiving a request to receive estimate prices from the seller terminal 200, the method may further include transmitting the characteristics information and the appearance image of the used car to a plurality of buying company terminals 600 located within a preset distance from a position of the user car. The method may further include transmitting estimate prices respectively received from the plurality of buying company terminals 600 to the seller terminal 200. The method may further include comparing, by the seller or car owner or by the seller or car owner terminal 200, the estimate prices and determining that the buying company offering the highest or best estimate price is the buying company to which to sell the used car.

The storage 10 may store the table in which the purchase price based on characteristics information of a car is recorded. Specifically, the storage 10 may store the table in which the export price based on characteristics information of a car is recorded. The storage 10 may further record the table in which the scrap car price based on characteristics information of a car is recorded. In this embodiment, the table in which the export price is recorded may be a table created by a pre-designated export company. In this embodiment, the export company agrees to buy the used car based on a price condition recorded in the table without directly looking at the used car. Furthermore, the table in which the scrap car price is recorded may be a table created by a pre-specified scrap car company. In this embodiment, the scrap car company agrees to buy a used car based on a price condition stored on the table without directly looking at the used car.

The storage 10 may include at least one type of a storage medium of a non-transitory memory such as a flash memory type, a hard disk type, a micro type, and a card type (e.g., SD card (Secure Digital Card) or XD card (extream Digital Card)) or a memory such as RAM (Random Access Memory), SRAM (Static RAM), ROM (Read-Only Memory), PROM (Programmable ROM), EEPROM (Electrically Erasable PROM), MRAM (Magnetic RAM), magnetic disk, and optical disk (optical disk).

The communicator 20 may be a module that provides a communication interface with the seller terminal 200, the used car management server 300, the market price management server 400, the maintenance company server 500, and the buying company terminal 600. The communicator 20 may include at least one of a mobile communication module, a wireless Internet module, or a short-range communication module.

The mobile communication module may communicate over a mobile communication network built according to technical standards or communication schemes for mobile communication (e.g., GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), LTEA (Long Term Evolution-Advanced), etc.).

The wireless Internet module may be a module for wireless Internet access, and may communicate over WLAN (Wireless LAN), Wi-Fi (Wireless-Fidelity), Wi-Fi (Wireless Fidelity) Direct, DLNA (Digital Living Network Alliance), WiBro (Wireless Broadband), World Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), and the like.

The short-range communication module may support the short-range communication using at least one of Bluetooth™, Radio Frequency Identification (RFID), Infrared Data Association (IrDA), Ultra Wideband (UWB), ZigBee, Near Field Communication (NFC), and Wireless USB (Wireless Universal Serial Bus).

The display 30 may display the unique information, the appearance image, and the position information of the used car input from the seller terminal 200. The display 30 may further display the market price of the used car obtained from the market price management server 400, the maintenance estimate cost of the used car obtained from the maintenance company server 500, the proper price of the used car determined based on the market price and the maintenance estimate cost of the used car. The display 30 may further include the purchase price of the used car retrieved from the table in which the purchase price based on characteristics information of a car is recorded and the estimate prices respectively received from the plurality of buying company terminals 600.

The controller 40 may perform overall controls so that each of the components may normally perform a function thereof. The controller 40 may be implemented by hardware, software, or a combination of hardware and software. Preferably, the controller 40 may be implemented as a microprocessor. However, the present disclosure is not limited thereto.

The controller 40 may receive data indicative of unique information, an appearance image, and position information of the used car from the seller terminal 200. The controller 40 may acquire characteristics information of the used car from the used car management server 300 using the unique information of the used car. The controller 40 may obtain a market price of the used car from the market price management server 400 using the characteristics information of the used car, acquire a maintenance estimate cost from the maintenance company server 500 using the appearance image of the used car, and subtract the maintenance estimate cost from the market price of the used car to determines a proper price of the used car. The controller 40 may transmit the proper price of the used car to the seller terminal, retrieve a purchase price of the used car from a table in which the purchase price based on characteristics information of a car is recorded, and transmit the purchase price of the used car to the seller terminal 200. The seller or car owner or the seller or car owner terminal 200 may accept or reject the purchase price and, if rejected, may send a request to receive estimate prices. Upon receiving a request to receive estimate prices to be compared with each other from the seller terminal 200, the controller 40 may transmit the characteristics information and the appearance image of the used car to a plurality of buying company terminals 600 located within a preset distance from a position of the user car. The controller 40 may transmit estimate prices respectively received from the plurality of buying company terminals 600 to the seller terminal 200. The seller or car owner or the seller or car owner terminal 200 may compare the received estimate prices and may determine and select or accept the best or highest estimate price. The seller or car owner or the seller or car owner terminal 200 may determine that the buying company terminal 600 offering the highest or best price is the buying company to which to sell the used car.

In an embodiment, the controller 40 may obtain the maintenance estimate price using a deep learning model without obtaining the maintenance estimate cost from the maintenance company server 500. In this embodiment, the deep learning model may be a model that has been trained based on a training dataset composed of the appearance image of the used car and a corresponding maintenance estimate cost. The deep learning model may output the maintenance estimate cost upon receiving the appearance image of the used car.

Furthermore, when brokering a used car transaction between a car owner and a used car export company, the controller 40 may receive data indicative of unique information, an appearance image, and position information of the used car from the car owner terminal 200. The controller 40 may further acquire the characteristics information of the used car from the used car management server 300 based on the unique information of the used car, acquire the market price of the used car from the market price management server 400 using the characteristics information of the used car, and acquire the maintenance estimate cost from the maintenance company server 500 using the appearance image of the used car. The controller 40 may further determine a proper export price of the used car by subtracting the maintenance estimate cost from the market price of the used car and transmit the proper export price of the used car to the car owner terminal 200. The controller 40 may retrieve the export price of the used car from the table in which the export price based on the characteristics information of the car is recorded and transmit the export price of the used car to the car owner terminal 200. Upon receiving a request of bid prices from the car owner terminal 200, the controller 40 may transmit the characteristics information and the appearance image of the used car to a plurality of export company terminals 610 located within a preset distance from the position of the used car and transmit the estimate prices respectively received from the plurality of export company terminals 610 to the car owner terminal 200. The controller 40 may further compare the estimate prices to determine the best or highest price.

In this embodiment, the controller 40 may acquire a market price history of the used car from the market price management server 400, determine a price reduction rate of the used car based on the market price history of the used car, and apply the price reduction rate of the used car to the proper export price of the used car or the proper price of the used car to determine a future market price of the used car. To this end, the controller 40 may use an artificial intelligence (AI) model.

Furthermore, when the controller 40 brokers a transaction between a car owner and a scrap car company, the controller 40 may receive the data indicative of the unique information, the appearance image, and the position information of the used car from the car owner terminal 200. The controller 40 may acquire the characteristics information of the used car from the used car management server 300 based on the unique information of the used car. The controller 40 may acquire the market price of the used car from the market price management server 400 based on the characteristics information of the used car. The controller 40 may further determine a damage level of the used car based on the appearance image of the used car and determine a proper scrap car price of the used car by subtracting a repair cost corresponding to the damage level from the market price of the used car. The controller may further transmit the proper scrap car price of the used car to the car owner terminal 200. The controller 40 may retrieve the scrap car price of the used car from the table in which the scrap car price based on the characteristics information of the car is recorded and transmit the scrap car price of the used car to the car owner terminal 200. Upon receiving a request to receive estimate prices from the car owner terminal 200, the controller 40 may further transmit the characteristics information and the appearance image of the used car to a plurality of scrap car company terminals 620 located within a preset distance from the position of the used car and transmit estimate prices respectively received from the plurality of scrap car company terminals 620 to the car owner terminal 200. The car owner terminal 200 may compare the estimate prices and determine which one is the best or highest estimate price.

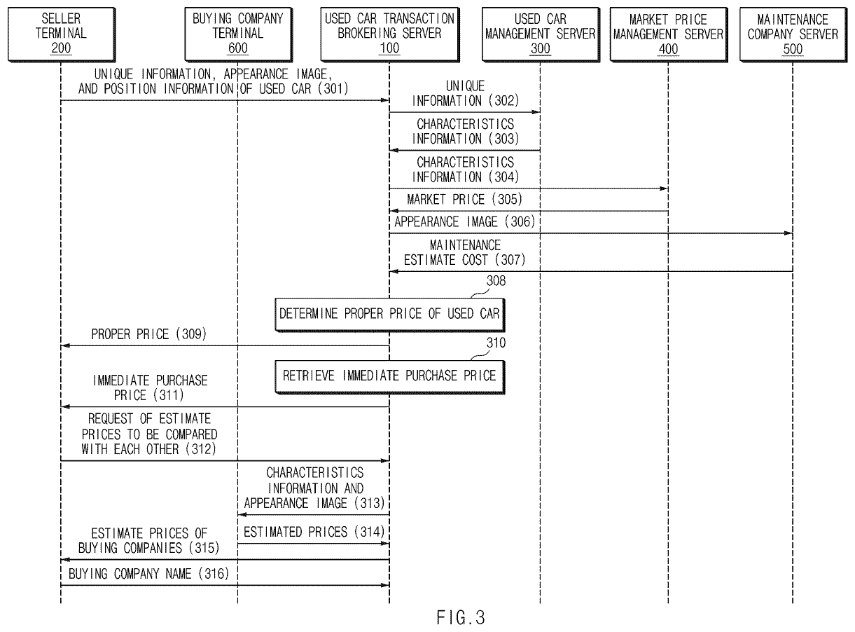

FIG. 3 is a flowchart illustrating a used car transaction brokering method according to an embodiment of the present disclosure.

The seller terminal 200 transmits unique information, an appearance image, and position information of the used car to the used car transaction brokering server 100 in operation 301.

Then, the used car transaction brokering server 100 transmits the unique information of the used car received from the seller terminal 200 to the used car management server 300 in operation 302.

Thereafter, the used car management server 300 detects the characteristics information of the used car from a database based on the unique information of the used car received from the used car transaction brokering server 100. The used car management server 300 transmits the detected characteristics information to the used car transaction brokering server 100 in operation 303.

Subsequently, the used car transaction brokering server 100 transmits the characteristics information of the used car received from the used car management server 300 to the market price management server 400 in operation 304.

Next, the market price management server 400 calculates the market price corresponding to the characteristics information of the used car and transmits the calculated market price to the used car transaction brokering server 100 in operation 305.

Thereafter, the used car transaction brokering server 100 transmits the appearance image of the used car to the maintenance company server 500 in operation 306.

Then, the maintenance company server 500 transmits the maintenance estimate cost corresponding to the appearance image of the used car to the used car transaction brokering server 100 in operation 307.

Then, the used car transaction brokering server 100 determines the proper price of the used car by subtracting the maintenance estimate cost from the market price of the used car in operation 308.

Thereafter, the used car transaction brokering server 100 transmits the proper price of the used car to the seller terminal 200 in operation 309.

Subsequently, the used car transaction brokering server 100 retrieves an immediate purchase price of the used car from the table in which the purchase price based on the characteristics information of a car is recorded in operation 310.

Then, the immediate purchase price of the used car is transmitted to the seller terminal 200 in operation 311. In this embodiment, the transaction is confirmed when the seller immediately accepts the purchase price (not shown). However, the seller may not accept the immediate purchase price and instead may send a request to receive estimate prices to the used car transaction brokering server 100.

Thus, upon receiving the request to receive the estimate prices from the seller terminal 200 in operation 312, the used car transaction brokering server 100 transmits the characteristics information and the appearance image of the used car to the plurality of buying company terminals 600 located within a predetermined distance from the position of the used car in operation 313.

Thereafter, the plurality of buying company terminals 600 transmit the estimated prices thereof to the used car transaction brokering server 100 in operation 314.

Thereafter, the used car transaction brokering server 100 transmits the estimate prices of the buying companies to the seller terminal 200 in operation 315.

Thereafter, the seller terminal 200 transmits a name of the buying company to which the seller determines to sell the used car to the used car transaction brokering server 100 in operation 316. In this regard, the seller may determine that the buying company offering the highest price as the buying company to which the seller determines to sell the used car.

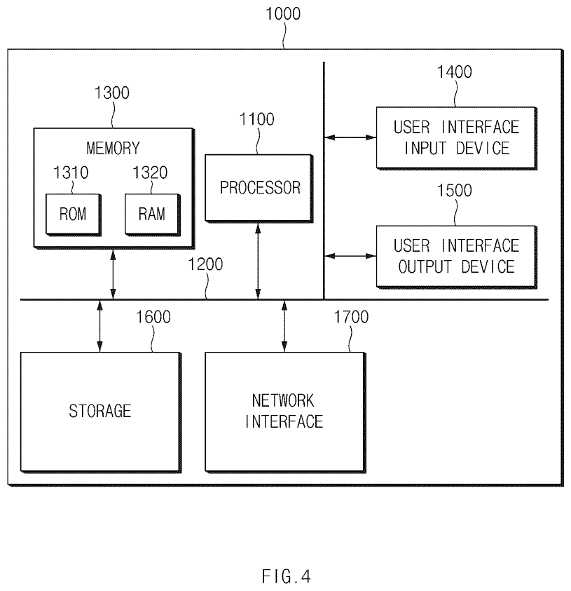

FIG. 4 is a block diagram showing a computing system for executing a used car transaction brokering method according to an embodiment of the present disclosure.

Referring to FIG. 4, the used car transaction brokering method according to an embodiment of the present disclosure as described above may also be implemented by the computing system 1000. The computing system 1000 may include at least one processor 1100, a memory 1300, a user interface input device 1400, a user interface output device 1500, storage 1600, and a network interface 1700 connected to each other via a system bus 1200. In an embodiment, each of the used car transaction server 100, the seller terminal 200, the used car management server 300, the market price management server 400, the maintenance company server 500, the buying company terminal 600, the export company terminal 610, and the scrap company terminal 620 may be implemented by the computing system 1000 including the at least one processor 1100.

The processor 1100 may be a central processing unit (CPU) or a semiconductor device that performs processing based on commands stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the embodiments disclosed herein may be embodied directly in hardware or a software module executed by the processor 1100, or in a combination thereof. The software module may reside on a storage medium (i.e., the memory 1300 and/or the storage 1600) such as a RAM, a flash memory, a ROM, an EPROM, an EEPROM, a register, a hard disk, a removable disk, and a CD-ROM. The example storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure. Various modifications and changes may be made by those of ordinary skill in the art without departing from the essential characteristics of the present disclosure. Therefore, the embodiments disclosed in the present disclosure are not intended to limit the technical idea of the present disclosure but to illustrate the present disclosure. The scope of the technical idea of the present disclosure is not limited by the embodiments. The scope of the present disclosure should be construed as being covered by the scope of the appended claims. All technical ideas falling within the scope of the claims should be construed as being included in the scope of the present disclosure.

The embodiments of the present disclosure may provide the used car transaction brokering system and a method capable of presenting the best transaction to both the seller and the buyer. The used car transaction brokering system and method receive unique information, an appearance image, and position information of the used car from a seller terminal. The used car transaction brokering system and method may acquire characteristics information of the used car from the used car management server using the unique information of the used car and acquire the market price of the used car from the market price management server based on the characteristics information of the used car. The used car transaction brokering system and method may acquire a maintenance estimate cost from the maintenance company server based on the appearance image of the used car, determine a proper price of the used car by subtracting the maintenance estimate cost from the market price of the used car, and transmit the proper price of the used car to the seller terminal. The used car transaction brokering system and method may retrieve the purchase price of the used car from a table in which the purchase price based on the characteristics information of a car is recorded and transmit the purchase price of the used car to the seller terminal. The seller terminal may accept the purchase price or may not accept the purchase price and instead may send a request to receive estimate prices. Upon receiving a request from the seller terminal to receive estimate prices to be compared with each other from the seller terminal, the used car transaction brokering system and method may transmit the characteristics information and the appearance image of the used car to a plurality of buying company terminals located within a preset distance from a position of the used car. The used car transaction brokering system and method may transmit estimate prices respectively received from the plurality of buying company terminals to the seller terminal. The seller or the seller terminal may determine that the buying company offering the highest price is the buying company to which the seller determines to sell the used car.

Hereinabove, although the present disclosure has been described with reference to various embodiments and the accompanying drawings, the present disclosure is not limited thereto. The embodiments of the present disclosure may be variously modified and altered by those of ordinary skill in the art to which the present disclosure pertains without departing from the spirit and scope of the present disclosure claimed in the following claims.

What is claimed is:

1. A used car transaction brokering device comprising:
a storage storing a table in which a purchase price based on characteristics information of a car is recorded; and
a controller coupled with the storage and configured to
receive data indicative of unique information, an appearance image, and position information of the used car from a seller terminal,
acquire characteristics information of the used car based on the unique information of the used car,
acquire a market price of the used car based on the characteristics information of the used car,
acquire a maintenance estimate cost based on the appearance image of the used car,
determine a proper price of the used car by subtracting the maintenance estimate cost from the market price of the used car,
transmit the proper price of the used car to the seller terminal,
retrieve the purchase price of the used car from the table,
transmit the purchase price of the used car to the seller terminal,
upon receiving a request to receive estimate prices to be compared with each other from the seller terminal,
transmit the characteristics information and the appearance image of the used car to a plurality of buying company terminals located within a preset distance from a position of the used car, and
transmit the estimate prices respectively received from the plurality of buying company terminals to the seller terminal.

2. The used car transaction brokering device of claim 1, wherein the storage stores therein a table in which an export price based on characteristics information of a car is recorded.

3. The used car transaction brokering device of claim 2, wherein, when brokering a used car transaction between a car owner and a used car export company, the controller is configured to:
receive the unique information, the appearance image and the position information of the used car from the seller terminal;
acquire the characteristics information of the used car using the unique information of the used car;
acquire the market price of the used car based on the characteristics information of the used car;
acquire the maintenance estimate cost using the appearance image of the used car;
determine a proper export price of the used car by subtracting the maintenance estimate cost from the market price of the used car;
transmit the proper export price of the used car to the seller terminal;
retrieve the export price of the used car from the table in which the export price based on the characteristics information of the car is recorded;
transmit the export price of the used car to the seller terminal;
upon receiving a request to receive export estimate prices to be compared with each other from the seller terminal, transmit the characteristics information and the appearance image of the used car to a plurality of export company terminals located within a preset distance from the position of the used car; and
transmit the export estimate prices respectively received from the plurality of export company terminals to the seller terminal.

4. The used car transaction brokering device of claim 3, wherein the controller is configured to:
determine a price reduction rate of the used car based on a market price history of the used car; and
apply the price reduction rate of the used car to the proper export price of the used car to determine a future market price of the used car.

5. The used car transaction brokering device of claim 1, wherein the storage stores therein a table in which a scrap car price based on characteristics information of a car is recorded.

6. The used car transaction brokering device of claim 5, wherein, in brokering a transaction between a car owner and a scrap company, the controller is configured to:
receive the unique information, the appearance image, and the position information of the used car from the seller terminal;
acquire the characteristics information of the used car using the unique information of the used car;
acquire the market price of the used car using the characteristics information of the used car;
determine a damage level of the used car using the appearance image of the used car;
determine a proper scrap car price of the used car by subtracting a repair cost corresponding to the damage level from the market price of the used car;
transmit the proper scrap car price of the used car to the seller terminal;
retrieve the scrap car price of the used car in the table in which the scrap car price based on the characteristics information of the car is recorded;
transmit the scrap car price of the used car to the seller terminal;
upon receiving a request to receive scrap estimate prices to be compared with each other from the seller terminal, transmit the characteristics information and the appearance image of the used car to a plurality of scrap car company terminals located within a preset distance from the position of the used car; and
transmit the scrap estimate prices respectively received from the plurality of scrap car company terminals to the seller terminal.

7. The used car transaction brokering device of claim 1, wherein the controller is configured to acquire the maintenance estimate cost using a deep learning model that has been trained.

8. The used car transaction brokering device of claim 7, wherein the deep learning model outputs the maintenance estimate cost corresponding to the appearance image of the used car.

9. The used car transaction brokering device of claim 1, wherein the unique information includes a license plate number and a vehicle identification number of the used car.

10. The used car transaction brokering device of claim 1, wherein the characteristics information includes at least one of a manufacturer, a vehicle type, a model name, a class (option), a color, a manufacturing year, a displacement, a type of fuel, a transmission type, a cumulative mileage, an acquisition price, a maintenance history, an insurance history, a lease and rental history, a car owner history, or any combination thereof.

11. A used car transaction brokering method comprising:
storing, into a storage, a table in which a purchase price based on characteristics information of a car is recorded;
receiving, by a controller, unique information, an appearance image, and position information of the used car from a seller terminal;
acquiring, by the controller, characteristics information of the used car based on the unique information of the used car;
acquiring, by the controller, a market price of the used car based on the characteristics information of the used car;
acquiring, by the controller, a maintenance estimate cost based on the appearance image of the used car;
determining, by the controller, a proper price of the used car by subtracting the maintenance estimate cost from the market price of the used car;
transmitting, by the controller, the proper price of the used car to the seller terminal;
retrieving, by the controller, the purchase price of the used car from the table;
transmitting, by the controller, the purchase price of the used car to the seller terminal;
upon receiving a request to receive estimate prices to be compared with each other from the seller terminal, transmitting, by the controller, the characteristics information and the appearance image of the used car to a plurality of buying company terminals located within a preset distance from a position of the used car; and
transmitting, by the controller, the estimate prices respectively received from the plurality of buying company terminals to the seller terminal.

12. The used car transaction brokering method of claim 11, further comprising:
storing, into the storage, a table in which an export price based on characteristics information of a car is recorded.

13. The used car transaction brokering method of claim 12, wherein, when brokering a used car transaction between a car owner and a used car export company, retrieving, by the controller, the purchase price of the used car includes:
retrieving, by the controller, the export price of the used car from the table in which the export price based on the characteristics information of the car is recorded.

14. The used car transaction brokering method of claim 13, wherein acquiring, by the controller, the market price of the used car includes:
determining, by the controller, a price reduction rate of the used car based on a market price history of the used car; and
applying, by the controller, the price reduction rate of the used car to a proper price of the used car to determine a future market price of the used car.

15. The used car transaction brokering method of claim 11, further comprising:
storing, into the storage, a table in which a scrap car price based on characteristics information of a car is recorded.

16. The used car transaction brokering method of claim 15, wherein, when brokering a transaction between a car owner and a scrap car company, determining, by the controller, the proper price of the used car includes:
determining, by the controller, a damage level of the used car using the appearance image of the used car; and
determining, by the controller, a proper scrap car price of the used car by subtracting a repair cost corresponding to the damage level from the market price of the used car.

17. The used car transaction brokering method of claim 11, wherein acquiring, by the controller, the maintenance estimate cost includes acquiring, by the controller, the maintenance estimate cost using a deep learning model that has been trained.

18. The used car transaction brokering method of claim 17, wherein the deep learning model outputs the maintenance estimate cost corresponding to the appearance image of the used car.

19. The used car transaction brokering method of claim 11, wherein the unique information includes a license plate number and a vehicle identification number of the used car.

20. The used car transaction brokering method of claim 11, wherein the characteristics information includes at least one of a manufacturer, a vehicle type, a model name, a class (option), a color, a manufacturing year, a displacement, a type of fuel, a transmission type, a cumulative mileage, an acquisition price, a maintenance history, an insurance history, a lease and rental history, a car owner history, or any combination thereof.
